(19) United States
(12) Patent Application Publication
(10) Pub. No.: US 2015/0134916 A1
(43) Pub. Date: May 14, 2015

(54) CACHE FILTER

(71) Applicant: NVIDIA Corporation, Santa Clara, CA (US)

(72) Inventors: Sudnya Padalikar, San Jose, CA (US); Gregory Fredrick Diamos, San Jose, CA (US)

(73) Assignee: NVIDIA Corporation, Santa Clara, CA (US)

(21) Appl. No.: 14/077,906

(22) Filed: Nov. 12, 2013

(51) Int. Cl. G06F 12/08

(52) U.S. Cl. CPC G06F 12/0888; G06F 2212/603
USPC 711/138

(57) ABSTRACT

A cache filter is described. More specifically, some implementations include techniques for classification of memory requests including calculating a probability that one or more memory regions are associated with a particular memory request, selecting one or more regions of the memory to receive memory requests based on the probability associated with the one or more regions, receiving one or more memory requests, determining that at least one of the memory requests is associated with one of the one or more selected regions of the memory, and providing the at least one memory request to the memory.

### TECHNICAL BACKGROUND

This disclosure relates to a cache filter for classification of memory requests.

### BACKGROUND

Caches for highly multi-threaded processors (e.g., 2048 hardware threads) can sometimes devote a relatively small amount of storage per thread (e.g., 4-words per-thread for a 32 KB L1 cache). This small amount of storage may render traditional replacement policies ineffective. Particularly, cache lines can be evicted by memory requests from other threads before they have an opportunity to be reused by the original thread, resulting in thrashing.

### SUMMARY

In some implementations, a probability is calculated that one or more memory regions are associated with a particular memory request. In some examples, the memory includes a cache (e.g., a L1 cache). One or more regions of the memory are selected to receive memory requests based on the probability associated with the one or more regions. In some examples, one or more memory requests are received and at least one of the memory requests is determined to be associated with one of the one or more selected regions of the memory. Furthermore, at least one memory request is provided to the memory.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

In a first aspect combinable with any of the general implementations, the selecting one or more regions includes comparing the probability of at least one of the one or more regions to a threshold, and selecting the one or more regions based on the probability associated with each of the one or more selected regions being above the threshold.

In a second aspect combinable with any of the previous aspects, including determining that at least another memory request is not associated with the one or more selected regions of the memory, and providing the at least another memory request to a different memory.

In a third aspect combinable with any of the previous aspects, including receiving one or more additional memory requests, and identifying a respective region of the memory corresponding to each additional memory request, wherein the probability for each of the one or more regions is based on a frequency of the additional memory requests associated with each of the one or more regions.

In a fourth aspect combinable with any of the previous aspects, the identifying includes identifying, for one or more of the additional memory requests, a memory address associated with the memory request, sorting the one or more additional memory requests by the respective memory address into one or more subsets of additional memory requests, identifying an address range associated with at least one of the one or more subsets of additional memory requests, comparing the address range associated with the one or more subsets of additional memory requests with a size of the memory, and determining that a first subset of additional memory requests does not exceed the size of the memory, and associating a particular region of the memory with the first subset of first memory requests.

In a fifth aspect combinable with any of the previous aspects, including comparing the address range associated with the one or more subsets of additional memory requests with the size of the memory, and determining that a second subset of additional memory requests exceeds the size of the memory, and denying an association of a region of the memory with the second subset of additional memory requests.

In a sixth aspect combinable with any of the previous aspects, including identifying a subset of the one or more additional memory requests based on (i) a time at which the additional memory requests are received and (ii) the region of the memory associated with the additional memory requests, and storing the subset of the one or more additional memory requests.

In a seventh aspect combinable with any of the previous aspects, wherein receiving the one or more memory requests includes receiving one or more transactions, each transaction including a subset of the one or more memory requests.

In an eighth aspect combinable with any of the previous aspects, wherein each region of the memory includes multiple memory addresses.

In a ninth aspect combinable with any of the previous aspects, wherein the determining includes comparing the one or more memory requests to the one or more selected regions.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example cache filter system;

FIG. 2 illustrates an example cache filter;

FIG. 3 illustrates an example region predictor;

FIG. 4 illustrates an example access filter;

FIG. 5 is a flow chart that illustrates a method for classification of memory requests;

FIG. 6 is a flow chart that illustrates a method for identifying a probability of future memory requests associated with each region;

FIG. 7 is a flow chart that illustrates a method for identifying a respective region of the memory corresponding to memory requests;

FIG. 8 is a flow chart that illustrates a method for storing memory requests; and

FIG. 9 illustrates an example computing system for implementing the cache filter system.

### DETAILED DESCRIPTION

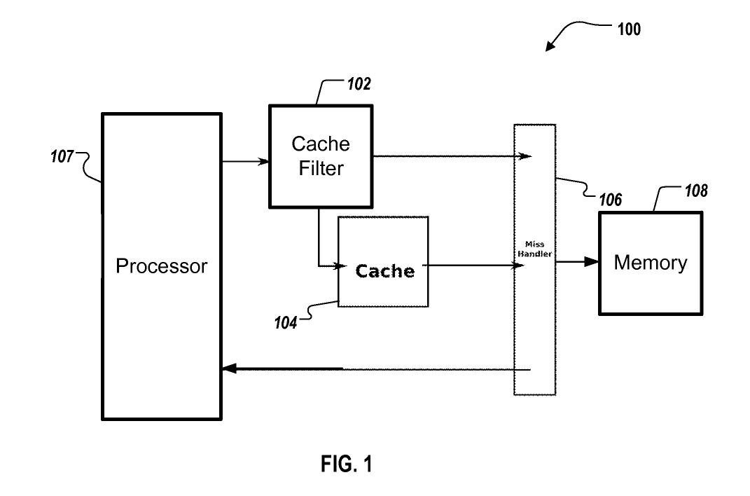

FIG. 1 illustrates an example cache filter system 100 for classification of memory requests. The cache filter system 100 may include a cache filter 102, a cache 104, and a miss-handler 106. In some examples, generally, the cache filter system 100 receives memory requests from a processor 107 and classifies memory requests into “cacheable” and “un-cacheable” categories. For example, “cacheable” memory requests are directed to the cache 104, while “un-cacheable”memory requests are directed to a memory system 108 (e.g., a main memory) though the miss-handler 106. In some examples, the miss handler 106 is an asynchronous miss-handler 106. In other words, performance can be improved by only sending memory requests to addresses that are shared among multiple threads to the cache 104 and filtering out accesses to addresses that are not.

The cache filter system 100 provides memory requests (e.g., memory accesses) to the cache 104 or to the (main) memory 108 (though the miss-handler 106). Specifically, the memory requests provided to the cache 104 can have one or more of the following properties: i) a portion of the memory requests are associated with an address range that is small enough to fit into the cache 104; ii) the memory requests exhibit spatial correlation; and iii) memory addresses that are accessed concurrently by the one or more processing threads (e.g., of the memory requests) are associated with less per-thread storage (as compared with addresses accessed independently by different threads). These properties facilitate tracking regions of the cache 104 that receive a large percentage of the total memory requests, and allowing these memory requests to access the cache 104.

In some examples, when the miss-handler 106 receives the memory requests, the miss-handler 106 allocates new storage (e.g., within the main memory 108) to hold the return data. Replies from the main memory 108 store data directly into the allocated storage for the memory requests, which either is forwarded directly to the processor 107 or to the cache 104, depending on which generated the memory request. Additionally, in some examples, the cache 104 also forwards memory requests to the miss-handler 106 without allocating a line in the cache 104 (e.g., when the cache 104 runs out of cache lines in a set). In response, the miss-handler 106 forwards the returned data directly to the processor 107.

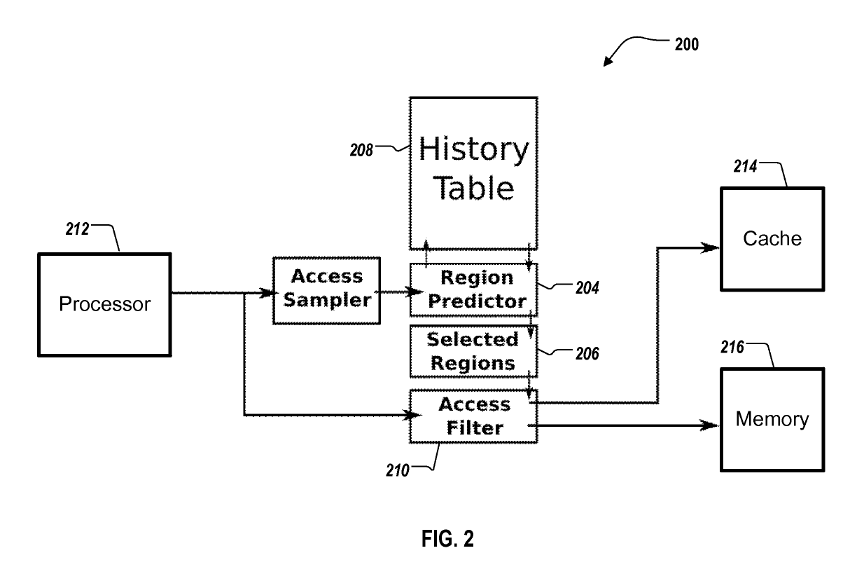

FIG. 2 illustrates an example cache filter 200, analogous to the cache filter 102. The cache filter 200 may include an access sampler 202, a region predictor 204, selected regions 206, a history table 208, and an access filter 210. In some examples, the access sampler 202 receives memory requests from a processor 212. The access sampler 202 filters the received memory requests to identify a subset of the memory requests (e.g., a “sample” of the memory requests to provide “sampled” memory requests). Specifically, in some examples, the cache filter 200, and in particular, the region predictor 204, processes the memory requests at a processing rate that is lower than the processing rate of the processor 212. In doing so, the access sampler 202 reduces the number of memory requests provided to the region predictor 204 such that the region predictor 204 is able to appropriately process new memory requests as they are received from the processor 212 (e.g., the region predictor 204 “keeps up” with the processor 212). For example, in a given time period, the processor 212 may provide thirty-two memory requests to the access sampler 202. The access sampler 202 reduces the thirty-two memory requests to a subset of one (or two) memory requests (selected without bias, i.e., randomly) to provide to the region predictor 204.

In some examples, the region predictor 204 provides a prediction model of the received memory requests from the access sampler 202. Specifically, in some implementations, a probability is calculated that one or more of the memory regions are associated with a particular memory request. For example, the region predictor 204 identifies a distribution (e.g., access pattern) of the memory requests with respect to the regions of a cache 214 (e.g., a region of the cache 214 that the processor is accessing) and associates the probability of a future memory request to a particular region of the cache 214. That is, the probability for each of the regions of the cache 214 being associated with a memory request (e.g., a future memory request) is based on a frequency of previously received memory requests (e.g., historical memory requests) being associated with a region. In some examples, the probability for each of the regions of the cache 214 being associated with a memory request (e.g., a future memory request) can be based on other criteria, such as a time associated with the memory requests or other metadata.

In some implementations, the region predictor 204 selects one or more regions to receive memory requests based on the probability associated with the one or more regions. For example, the region predictor 204 identifies historical memory requests, maps the historical memory requests to one or more regions of the cache 214 and selects one or more regions (i.e., the selected regions 206) that are associated with the greatest number of memory requests (e.g., a highest frequency of memory requests). In other words, for a large enough value of N memory requests (e.g., based on the size of the cache or the total number of memory requests received), each sample of the memory requests is taken as a predictor of 1/N of future memory requests.

In some examples, the region predictor 204 compares the respective probability of the regions to a threshold. The threshold can be based on a user-submitted threshold, historical activity associated with the cache filter system 100, a baseline threshold, or other criteria. The region predictor 204 can select one or more regions (e.g., the selected regions 206) based on the probability associated with the selected regions being above a threshold. For example, the selected regions each are associated with a probability of a future memory request above the threshold. In some examples, the region predictor 204 selects the selected regions based on the regions associated with the highest percentage of memory requests. That is, a particular region can be associated with a particular percentage of the memory requests that is substantially greater than the percentage associated with the remaining regions. For example, the particular region can be associated with twenty-five percent of the memory requests, while the next highest percentage associated with a region is five percent. Thus, the region predictor 204 can select the particular region as a selected region.

In some examples, the region predictor 204 selects the selected regions based on a threshold number (e.g., a “top 10” list). For example, the region predictor 204 selects a predetermined number of regions having the highest probability. In some example, the predetermined number is user-provided, or based on historical activity (or trends). In some examples, the region predictor 204 selects the regions based on a combination of the aforementioned selection means. Additionally, in some implementations, the region predictor 204 selects the selected regions 206 further based on a size of the memory requests and the size of the cache 214. That is, the region predictor 204 selects the selected regions based on the memory requests associated with a region being able to be included (spatially) by the cache 214. For example, the summation of the size of the memory requests associated with a region does not exceed the capacity associate with the cache 214.

In some examples, the selected regions 206 are contiguous portions of the cache 214, and include (or span) multiple cache lines. In other words, the selection regions 206 are of courser granularity than individual lines of the cache 214. For example, a selected region 206 can include thirty-two cache lines. In some examples, by employing regions of the cache 214, a larger number of memory requests can be determined to be a cache hit or a cache miss (e.g., over a given time period).

In some examples, the history table 208 is in communication with the region predictor 204 and stores a subset of the memory requests provided by the access sampler 202, and further provides the subset of stored memory requests to the region predictor 204 to facilitate the region predictor 204 providing the aforementioned prediction model. The history table 208 stores the subset of the memory requests based on, among other things, a time at which the memory requests are received (e.g., by the access sampler 202), and a region (or regions) of the cache 214 that is associated with the memory requests.

In some examples, the access filter 210 filters the memory requests based on the selected regions 206. Specifically, in some implementations, the access filter 210 receives (additional) memory requests from the processor 212. In some examples, the access filter 210 receives transactions that include the memory requests. That is, each transaction includes one or more memory requests (e.g., a group of memory requests). In some examples, the transactions include contiguous memory requests. In some examples, each transaction includes a similar (or same) number of memory requests.

In some implementations, the access filter 210 determines that a memory request is associated with a selected region 206 of the selected regions of the cache 214. Specifically, the access filter 210 determines that a memory request received from the processor 212 is associated with a selected region 206. That is, a memory address associated with the memory request is associated with a selected region 206 that includes the memory address (e.g., spans memory addresses including the memory address of the memory request), detailed further below. In some examples, determining that the memory request is associated with a selected region 206 includes comparing the memory request to the selected region. For example, comparing can include comparing the memory address associated with the memory requests with each of the selected regions. Based upon the comparing, the access filter 210 determines that the memory request is associated with a selected region 206 (e.g., the selected region 206 includes the memory address associated with the memory request).

In some implementations, the access filter 210 provides the memory request to the cache 214. That is, the access filter 210 determines that the memory request is associated with the selected region 206, and in response, provides the memory request to the cache 214. In some examples, providing the memory request to the cache 214 further includes allowing accesses to the cache 214 by the memory request.

In some further implementations, the access filter 210 determines that a memory request is not associated with any of the selected regions 206. Specifically, the access filter 210 determines that a memory request received from the processor 212 is not associated with any of the selected regions 206. That is, the memory address associated with the selected regions 206 (e.g., the memory addresses spanned by each of the selected regions 206) do not include the memory address associated with the memory request. In response to such a determination, the access filter 210 provides the memory request to a main memory 216 (or the miss handler 106). In some examples, the access filter 210 bypasses providing the memory request to the cache 214.

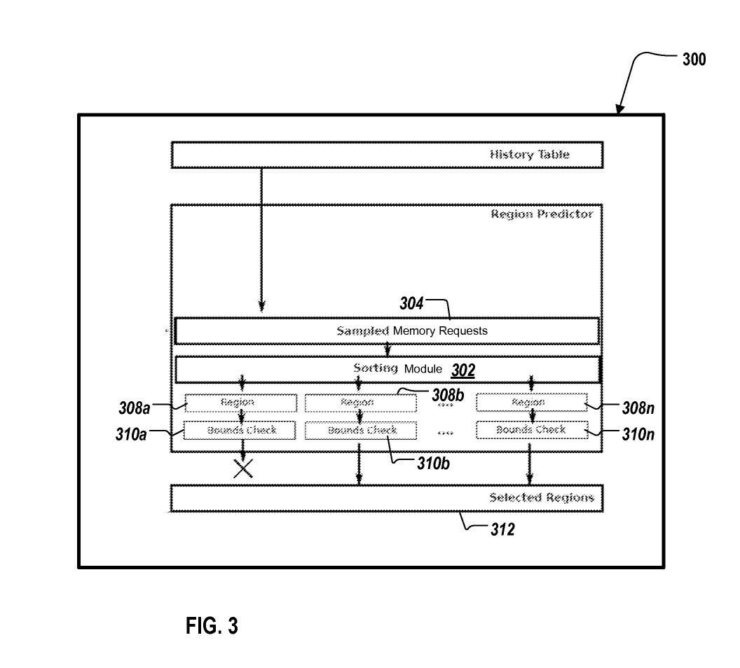

FIG. 3 illustrates an example region predictor 300, analogous to the region predictor 204. The region predictor 300 includes a sorting module 302. In some implementations, the region predictor 300 receives memory requests (e.g., from the access sampler 202), as sampled memory requests 304. The region predictor 300 identifies a memory address associated with the received memory requests. The sorting module 302 sorts the sampled memory requests 304 by their respective memory addresses into subsets of memory requests. For example, the sampled memory requests 304 are partitioned into equal-sized groups (e.g., the same number of sampled memory requests in each group).

The sorting module 302 identifies an address range associated with the subsets of the sampled memory requests 304. In some examples, each subset (or group) includes sampled memory requests 304 from nearby memory address (e.g., spatial-correlated). That is, in some examples, the subsets (or groups) include sampled memory requests 304 where the minimum and the maximum memory address is no further apart than x bytes (with x<the cache size) from the regions that are predicted to include a significant fraction of future memory requests. For example, the sorting module 302 sorts the sampled memory regions 304 in ascending order by their size (e.g., maximum address to minimum address) to provide regions 308a, 308b, . . . , 308n (collectively referred to as regions 308).

The sorting module 302 compares the address range associated with the subsets of the sampled memory requests 304 with a size of the cache (e.g., the cache 104, 214) and determines whether the subset of sampled memory requests 304 exceeds the size of the cache. For example, the sorting module 302 compares the address range of the regions 308 with the size of the cache by a respective bounds check module 310 (e.g., bounds check modules 310a, 310b, . . . , 310n). In some examples, the region predictor 300 determines that a subset of the sampled memory requests 304 does not exceed the size of the cache. In response, the region predictor 300 associates a particular region of the cache with the subset of the sampled memory requests 304 as selected regions 312, analogous to the selected regions 206. In some examples, the region predictor 304 determines that a subset of the sampled memory requests 304 does exceed the size of the cache, and in response, denies an association of a region of the cache with the subset of sampled memory requests 304.

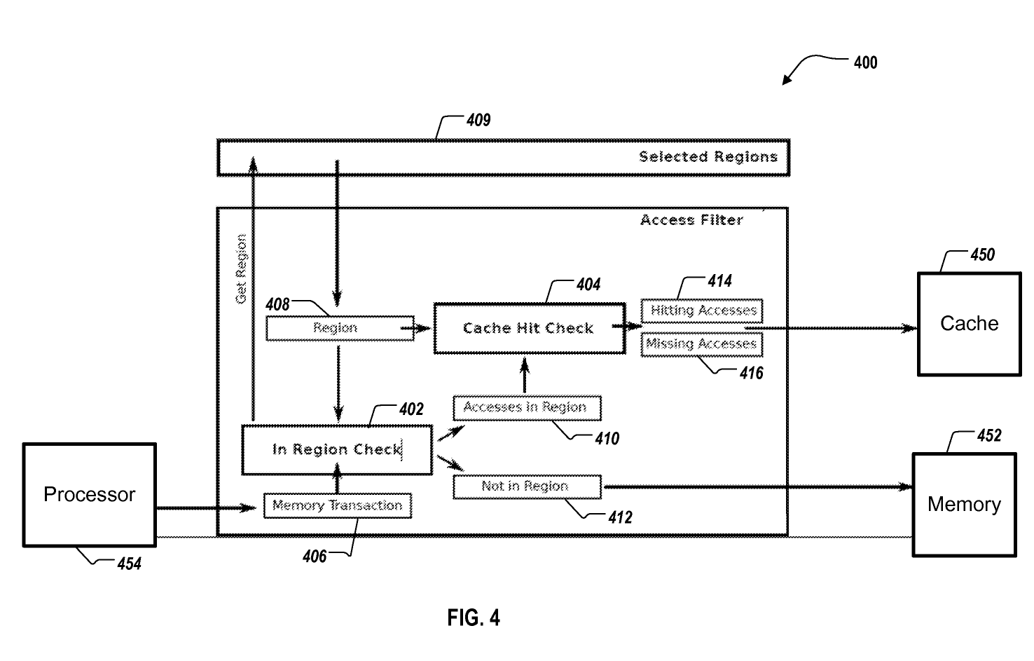

FIG. 4 illustrates an example access filter 400, analogous to the access filter 210. In general, the access filter 400 compares the received memory requests from a processor 454 against the selected regions (e.g., the selected regions 206, 312). Based on this comparison, the memory requests are provided to a cache 450, or to a main memory 452 (or the miss-handler 106). The access filter 400 includes a region check module 402 and a cache hit check module 404. Specifically, memory transactions 406 (e.g., received memory requests from the processor 454) are provided to the region check module 402. The region check module 402 further receives one or more selected regions 408 from selected regions 409 (analogous to the selected regions 206, 312). In some examples, the region check module 402 requests the selected region(s) 408. The region check module 402 determines whether the memory address associated with the memory requests of the memory transaction 406 is within the selected region(s) 408. In response to determining that the addresses of the memory requests are not within the selected region(s) 408, illustrated as an access 412, the memory requests are provided to the main memory 452 (or the miss-handler 106).

In some implementations, in response to determining that the addresses of the memory requests are within at least one of the selected region(s) 408, illustrated as an access 410, the cache hit check module 404 determines whether the memory request is a cache hit 414 or a cache miss 416. Additionally, the cache hit check module 404 provides the cache hits 414 and the cache misses 416 (e.g., the memory requests) to the cache 450.

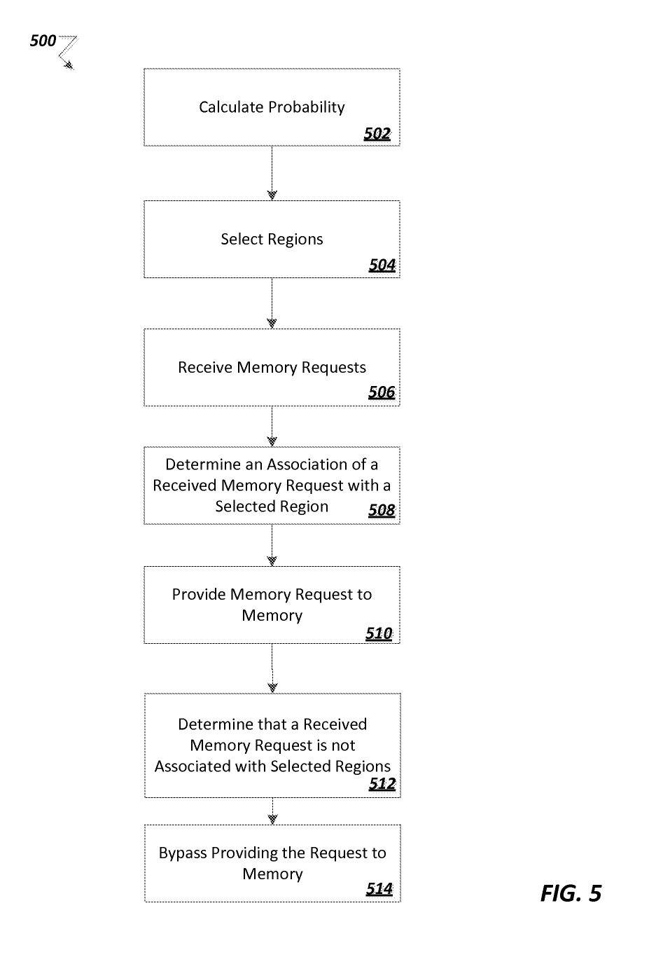

FIG. 5 illustrates a flow chart that illustrates a method for classification of memory requests. For clarity of presentation, the description that follows generally describes method 500 in the context of FIGS. 1-4. For example, as illustrated, particular steps of the method 500 may be performed by the cache filter system 100, the cache filter 200, the region predictor 300, and/or the access filter 400. However, method 500 may be performed, for example, by any other suitable system, environment, software, and hardware, or a combination of systems, environments, software, and hardware as appropriate.

At step 502, a probability is calculated that one or more memory regions are associated with a particular memory request. In some examples, each region of the memory includes multiple memory addresses. In some examples, the memory includes a cache. At step 504, one or more regions of the memory are selected to receive memory requests based on the probability associated with the one or more regions. In some examples, the probability of at least one of the one or more regions is compared to a threshold. In some examples, the one or more regions are selected based on the probability associated with each of the one or more selected regions being above the threshold. At step 506, one or more memory requests are received. In some examples, receiving the one or more memory requests includes receiving one or more transactions, each transaction including a subset of the one or more memory requests. At step 508, at least one of the memory requests is determined to be associated with one of the one or more selected regions of the memory. In some examples, the determining includes comparing the one or more memory requests to the one or more selected regions. At step 510, at least one memory request is provided to the memory (e.g., the cache 104). At step 512, at least another memory request is determined not to be associated with the one or more selected regions of the memory. A step 514, providing the at least another memory request to a different memory (e.g., the main memory 108). In some examples, providing the at least another memory request includes bypass providing the memory request to the memory (e.g., the cache 104).

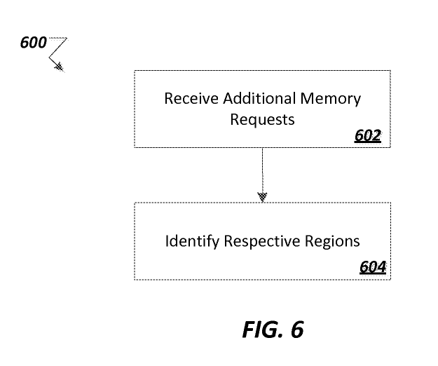

FIG. 6 illustrates a flow chart that illustrates a method for identifying a probability of future memory requests associated with each region. For clarity of presentation, the description that follows generally describes method 600 in the context of FIGS. 1-4. For example, as illustrated, particular steps of the method 600 may be performed by the cache filter system 100, the cache filter 200, the region predictor 300, and/or the access filter 400. However, method 600 may be performed, for example, by any other suitable system, environment, software, and hardware, or a combination of systems, environments, software, and hardware as appropriate.

At step 602, one or more additional memory requests are received. At step 604, a respective region of the memory corresponding to each additional memory request is identified. In some examples, the probability for each of the one or more regions is based on a frequency of the additional memory requests associated with each of the one or more regions.

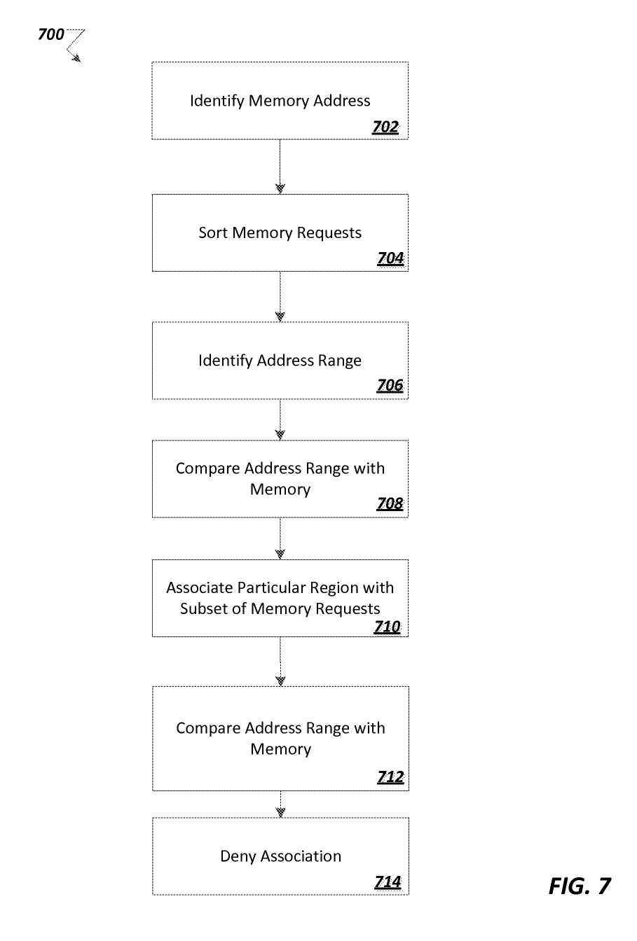

FIG. 7 illustrates a flow chart that illustrates a method for identifying a respective region of the memory corresponding to memory requests. For clarity of presentation, the description that follows generally describes method 700 in the context of FIGS. 1-4. For example, as illustrated, particular steps of the method 700 may be performed by the cache filter system 100, the cache filter 200, the region predictor 300, and/or the access filter 400. However, method 700 may be performed, for example, by any other suitable system, environment, software, and hardware, or a combination of systems, environments, software, and hardware as appropriate.

At step 702, for one or more of the additional memory requests, a memory address associated with the memory request is identified. At step 704, the one or more additional memory requests are sorted by the respective memory address into one or more subsets of additional memory requests. At step 706, an address range associated with at least one of the one or more subsets of additional memory requests is identified. At step 708, the address range associated with the one or more subsets of additional memory requests is compared with a size of the memory, and a first subset of additional memory requests that does not exceed the size of the memory is determined. At step 710, a particular region of the memory is associated with the first subset of first memory requests. At step 712, in some examples, the address range associated with the one or more subsets of additional memory requests is compared with the size of the memory, and a second subset of additional memory requests is determined to exceed the size of the memory. At step 714, in some examples, an association of a region of the memory with the second subset of additional memory requests is denied.

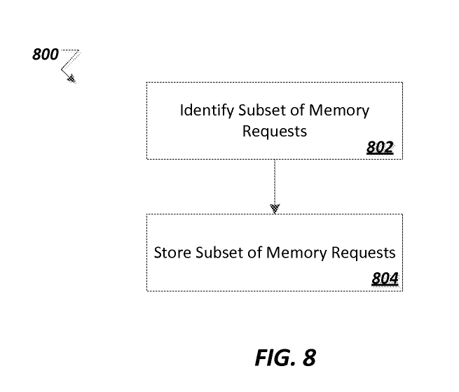

FIG. 8 illustrates a flow chart that illustrates a method for storing memory requests. For clarity of presentation, the description that follows generally describes method 800 in the context of FIGS. 1-4. For example, as illustrated, particular steps of the method 800 may be performed by the cache filter system 100, the cache filter 200, the region predictor 300, and/or the access filter 400. However, method 800 may be performed, for example, by any other suitable system, environment, software, and hardware, or a combination of systems, environments, software, and hardware as appropriate.

At step 802, a subset of the one or more additional memory requests is identified based on (i) a time at which the additional memory requests are received and (ii) the region of the memory associated with the additional memory requests. At step 804, the subset of the one or more additional memory requests is stored.

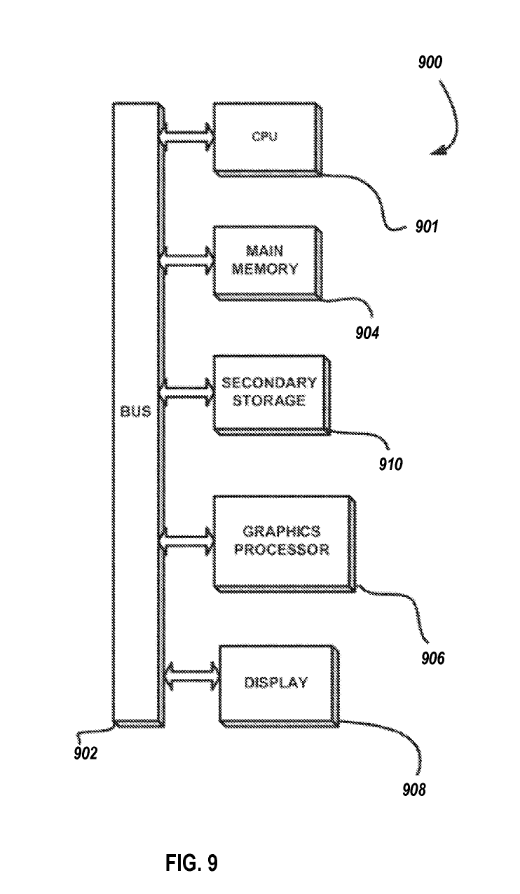

FIG. 9 depicts an example computing system 900 for implementing the cache filter system 100. Of course, the system 100 may be implemented in any desired environment. As shown, a system 900 is provided including at least one CPU 901 which is connected to a communication bus 902. The system 900 also may include main memory 904 (e.g., random access memory (RAM)). The system 900 may also include a graphics processor 906 and a display 908. In some implementations, the graphics processor 906 may include a plurality of shader modules, a rasterization module, etc. Each of the foregoing modules may even be situated together to form a graphics processing unit (GPU).

The system 900 may also include a secondary storage 910. The secondary storage 910 includes, for example, a hard disk drive and/or a removable storage drive, representing a solid state drive, a magnetic tape drive, a compact disk drive, etc. The removable storage drive reads from and/or writes to a removable storage unit in a well-known manner.

Computer programs, or computer control logic algorithms, may be stored in the main memory 904 and/or the secondary storage 910. Such computer programs, when executed, enable the system 900 to perform various functions. Memory 904, storage 910 and/or any other storage are possible examples of computer-readable media.

In some implementations, the architecture and/or functionality of the various previous figures may be implemented in the context of the CPU 901, graphics processor 906, or a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, a mobile system, and/or any other desired system, for that matter. Just by way of example, the system may include a desktop computer, lap-top computer, hand-held computer, mobile phone, personal digital assistant (PDA), peripheral (e.g. printer, etc.), any component of a computer, and/or any other type of logic.

While this document contains many specific implementation details, these should not be construed as limitations on the scope what may be claimed, but rather as descriptions of features that may be specific to particular implementations or embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A method comprising:
calculating a probability that one or more memory regions are associated with a particular memory request;
selecting one or more regions of the memory to receive memory requests based on the probability associated with the one or more regions;
receiving one or more memory requests;
determining that at least one of the memory requests is associated with one of the one or more selected regions of the memory; and
providing the at least one memory request to the memory.

2. The method of claim 1, wherein the memory is a cache.

3. The method of claim 1, wherein the selecting one or more regions comprises:
comparing the probability of at least one of the one or more regions to a threshold; and
selecting the one or more regions based on the probability associated with each of the one or more selected regions being above the threshold.

4. The method of claim 1 further comprising:
determining that at least another memory request is not associated with the one or more selected regions of the memory; and
providing the at least another memory request to a different memory.

5. The method of claim 1 comprising:
receiving one or more additional memory requests; and
identifying a respective region of the memory corresponding to each additional memory request,
wherein the probability for each of the one or more regions is based on a frequency of the additional memory requests associated with each of the one or more regions.

6. The method of claim 5, wherein the identifying comprises:
identifying, for one or more of the additional memory requests, a memory address associated with the memory request;
sorting the one or more additional memory requests by the respective memory address into one or more subsets of additional memory requests;
identifying an address range associated with at least one of the one or more subsets of additional memory requests;
comparing the address range associated with the one or more subsets of additional memory requests with a size of the memory, and determining that a first subset of additional memory requests does not exceed the size of the memory; and
associating a particular region of the memory with the first subset of first memory requests.

7. The method of claim 6 comprising:
comparing the address range associated with the one or more subsets of additional memory requests with the size of the memory, and determining that a second subset of additional memory requests exceeds the size of the memory; and
denying an association of a region of the memory with the second subset of additional memory requests.

8. The method of claim 5 comprising:
identifying a subset of the one or more additional memory requests based on (i) a time at which the additional memory requests are received and (ii) the region of the memory associated with the additional memory requests; and
storing the subset of the one or more additional memory requests.

9. The method of claim 1, wherein receiving the one or more memory requests comprises receiving one or more transactions, each transaction including a subset of the one or more memory requests.

10. The method of claim 1, wherein each region of the memory includes multiple memory addresses.

11. The method of claim 1, wherein the determining comprises comparing the one or more memory requests to the one or more selected regions.

12. A system, comprising:
a region predictor configured to:
calculate a probability that one or more memory regions are associated with a particular memory request;
select one or more regions of the memory to receive memory requests based on the probability associated with the one or more regions;
an access filter configured to:
receive one or more memory requests;
determine that at least one of the memory requests is associated with one of the one or more selected regions of the memory; and
provide the at least one memory request to the memory.

13. The system of claim 12, wherein the access filter is configured to:
determine that at least another memory request is not associated with the one or more selected regions of the memory; and
providing the at least another memory request to a different memory.

14. The system of claim 12, wherein the region predictor is configured to:
receive one or more additional memory requests; and
identify a respective region of the memory corresponding to each additional memory request,
wherein the probability for each of the one or more regions is based on a frequency of the additional memory requests associated with each of the one or more regions.

15. The system of claim 14, wherein the region predictor is configured to:
identify, for one or more of the additional memory requests, a memory address associated with the memory request;
sort the one or more additional memory requests by the respective memory address into one or more subsets of additional memory requests;
identify an address range associated with at least one of the one or more subsets of additional memory requests;
compare the address range associated with the one or more subsets of additional memory requests with a size of the memory, and determining that a first subset of additional memory requests does not exceed the size of the memory; and
associate a particular region of the memory with the first subset of first memory requests.

16. The system of claim 15, wherein the region predictor is configured to:
compare the address range associated with the one or more subsets of additional memory requests with the size of the memory, and determining that a second subset of additional memory requests exceeds the size of the memory; and
deny an association of a region of the memory with the second subset of additional memory requests.

17. A system comprising:
a cache memory; and
a cache memory controller configured to:
determine, for one or more regions of the cache memory, a probability that the region is associated with a particular memory request;
select one or more regions of the cache memory based on the probability associated with the one or more regions;
receive one or more memory requests;
compare each memory request to the one or more selected regions and determine that at least one memory request is associated with a particular selected region of the one or more selected regions; and
in response to the determination, provide the at least one memory request to the cache memory.

18. The system of claim 17, wherein the cache memory controller is configured to:
determine that at least another memory request is not associated with the one or more selected regions of the cache memory; and
provide the at least another memory request to a different memory.

19. The system of claim 17, wherein the cache memory controller is configured to:
receive one or more additional memory requests; and
identify a respective region of the cache memory corresponding to each additional memory request,
wherein the probability for each of the one or more regions is based on a frequency of the additional memory requests associated with each of the one or more regions.

20. The system of claim 17, wherein the cache memory controller is configured to:
identify, for one or more of the additional memory requests, a memory address associated with the memory request;
sort the one or more additional memory requests by the respective memory address into one or more subsets of additional memory requests;
identify an address range associated with at least one of the one or more subsets of additional memory requests;
compare the address range associated with the one or more subsets of additional memory requests with a size of the memory, and determining that a first subset of additional memory requests does not exceed the size of the memory; and
associate a particular region of the cache memory with the first subset of first memory requests.
